(19) United States
(12) Patent Application Publication
(10) Pub. No.: US 2016/0110310 A1
(43) Pub. Date: Apr. 21, 2016

(54) CACHE MANAGEMENT

(71) Applicant: Google Inc., Mountain View, CA (US)

(72) Inventor: JEREMY NELSON, Ultimo (AU)

(73) Assignee: Google Inc., Mountain View, CA (US)

(21) Appl. No.: 13/730,560

(22) Filed: Dec. 28, 2012

(51) Int. Cl. G06F 15/167

(52) U.S. Cl. CPC G06F 15/167

(57) ABSTRACT

A computer-implemented method, computer program product and computing system for receiving, on a second computing device, a read request from a user for web content local to the second computing device. An invalidation token is received for the web content local to the second computing device. The invalidation token includes a last modified timestamp for the web content local to the second computing device. The invalidation token is processed to determine if the web content local to the second computing device is substantially similar to web content local to a first computing device. If the web content local to the second computing device is substantially similar to the web content local to a first computing device, the web content local to the second computing device is provided to the user. If the web content local to the second computing device is not substantially similar to the web content local to the first computing device, the web content local to the first computing device is obtained and provided to the user.

### BACKGROUND

Caching is a method for transparently storing data to increase the speed of future data access, lower bandwidth costs and/or lower the cost of producing the data. Web caches are a particular application of caching that typically stores completely rendered webpages in a large storage medium indexed by the URL of the webpage. Client requests (e.g. from a web browser) may be sent to the web cache that may use the requested URL to determine if there is a valid locally-stored copy of the webpage, in which case it may be returned to the client. Alternatively, the request may be forwarded on to the server that provides content for that URL, the content may be rendered and returned, a local copy may be stored (cached) and a copy may be returned to the client. When the locally-cached content can be returned to the client (a ‘cache hit’), access from the client's perspective is generally much faster, as the server that would otherwise have had to render the content is relieved of the work required and network bandwidth is saved.

### SUMMARY OF DISCLOSURE

In one implementation, a computer-implemented method includes receiving, on a second computing device, a read request from a user for web content local to the second computing device. An invalidation token is received for the web content local to the second computing device. The invalidation token includes a last modified timestamp for the web content local to the second computing device. The invalidation token is processed to determine if the web content local to the second computing device is substantially similar to web content local to a first computing device. If the web content local to the second computing device is substantially similar to the web content local to a first computing device, the web content local to the second computing device is provided to the use. If the web content local to the second computing device is not substantially similar to the web content local to the first computing device, the web content local to the first computing device is obtained and provided to the user.

One or more of the following features may be included. The web content local to the first computing device may be at least a portion of a website. The web content local to the first computing device may be at least a portion of a weblog. The invalidation token may include a last modified timestamp for the web content local to the first computing device.

Processing the invalidation token to determine if the web content local to the second computing device is substantially similar to the web content local to the first computing device may include determining a last modified timestamp for the web content local to the second computing device. Processing the invalidation token to determine if the web content local to the second computing device is substantially similar to the web content local to the first computing device may include comparing the last modified timestamp for the web content local to the second computing device to the last modified timestamp for the web content local to the first computing device. The web content local to the second computing device may be substantially similar to the web content local to the first computing device if the last modified timestamp for the web content local to the second computing device matches the last modified timestamp for the web content local to the first computing device. The web content local to the second computing device may not be substantially similar to the web content local to the first computing device if the last modified timestamp for the web content local to the second computing device is older than the last modified timestamp for the web content local to the first computing device.

In another implementation, a computer program product resides on a computer readable medium that has a plurality of instructions stored on it. When executed by a processor, the instructions cause the processor to perform operations including receiving, on a second computing device, a read request from a user for web content local to the second computing device. An invalidation token is received for the web content local to the second computing device. The invalidation token includes a last modified timestamp for the web content local to the second computing device. The invalidation token is processed to determine if the web content local to the second computing device is substantially similar to web content local to a first computing device. If the web content local to the second computing device is substantially similar to the web content local to a first computing device, the web content local to the second computing device is provided to the use. If the web content local to the second computing device is not substantially similar to the web content local to the first computing device, the web content local to the first computing device is obtained and provided to the user.

One or more of the following features may be included. The web content local to the first computing device may be at least a portion of a website. The web content local to the first computing device may be at least a portion of a weblog. The invalidation token may include a last modified timestamp for the web content local to the first computing device.

Processing the invalidation token to determine if the web content local to the second computing device is substantially similar to the web content local to the first computing device may include determining a last modified timestamp for the web content local to the second computing device. Processing the invalidation token to determine if the web content local to the second computing device is substantially similar to the web content local to the first computing device may include comparing the last modified timestamp for the web content local to the second computing device to the last modified timestamp for the web content local to the first computing device. The web content local to the second computing device may be substantially similar to the web content local to the first computing device if the last modified timestamp for the web content local to the second computing device matches the last modified timestamp for the web content local to the first computing device. The web content local to the second computing device may not be substantially similar to the web content local to the first computing device if the last modified timestamp for the web content local to the second computing device is older than the last modified timestamp for the web content local to the first computing device

In another implementation, a computing system includes at least one processor and at least one memory architecture coupled with the at least one processor, wherein the computing system is configured to perform operations including receiving, on a second computing device, a read request from a user for web content local to the second computing device. An invalidation token is received for the web content local to the second computing device. The invalidation token includes a last modified timestamp for the web content local to the second computing device. The invalidation token is processed to determine if the web content local to the second computing device is substantially similar to web content local to a first computing device. If the web content local to the second computing device is substantially similar to the web content local to a first computing device, the web content local to the second computing device is provided to the use. If the web content local to the second computing device is not substantially similar to the web content local to the first computing device, the web content local to the first computing device is obtained and provided to the user.

One or more of the following features may be included. The web content local to the first computing device may be at least a portion of a website. The web content local to the first computing device may be at least a portion of a weblog. The invalidation token may include a last modified timestamp for the web content local to the first computing device.

Processing the invalidation token to determine if the web content local to the second computing device is substantially similar to the web content local to the first computing device may include determining a last modified timestamp for the web content local to the second computing device. Processing the invalidation token to determine if the web content local to the second computing device is substantially similar to the web content local to the first computing device may include comparing the last modified timestamp for the web content local to the second computing device to the last modified timestamp for the web content local to the first computing device. The web content local to the second computing device may be substantially similar to the web content local to the first computing device if the last modified timestamp for the web content local to the second computing device matches the last modified timestamp for the web content local to the first computing device. The web content local to the second computing device may not be substantially similar to the web content local to the first computing device if the last modified timestamp for the web content local to the second computing device is older than the last modified timestamp for the web content local to the first computing device

These and other aspects of this disclosure may provide one or more advantages, examples of which may include but are not limited to: ensuring that a locally-cached version of web content is current without needing to communicate with and/or exchange data with a remote server; and avoiding communication delays associated with communications between geographically-dispersed servers.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a storage system and a cache management process coupled to a distributed computing network according to an implementation of the present disclosure;

FIG. 2 is a diagrammatic view of the storage system of FIG. 1 according to an implementation of the present disclosure;

FIG. 3 is a flowchart of the cache management process of FIG. 1 according to an implementation of the present disclosure; and

FIG. 4 is another diagrammatic view of the storage system of FIG. 1 according to an implementation of the present disclosure.

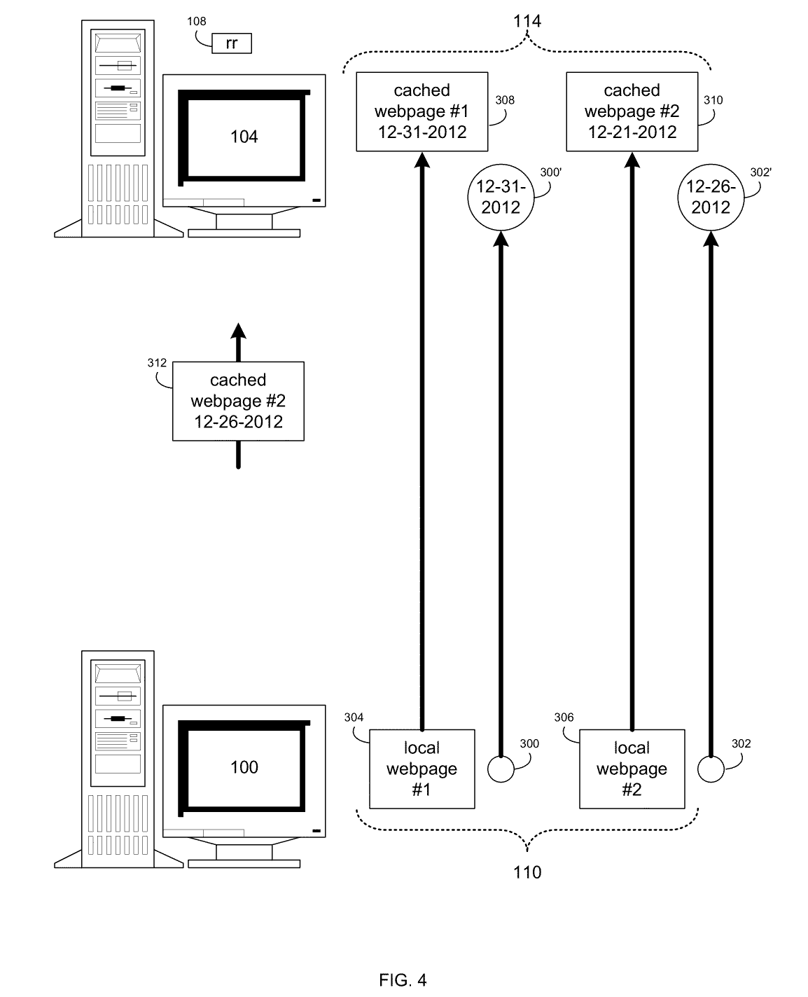

Like reference symbols in the various drawings indicate like elements.

### DETAILED DESCRIPTION OF THE IMPLEMENTATIONS

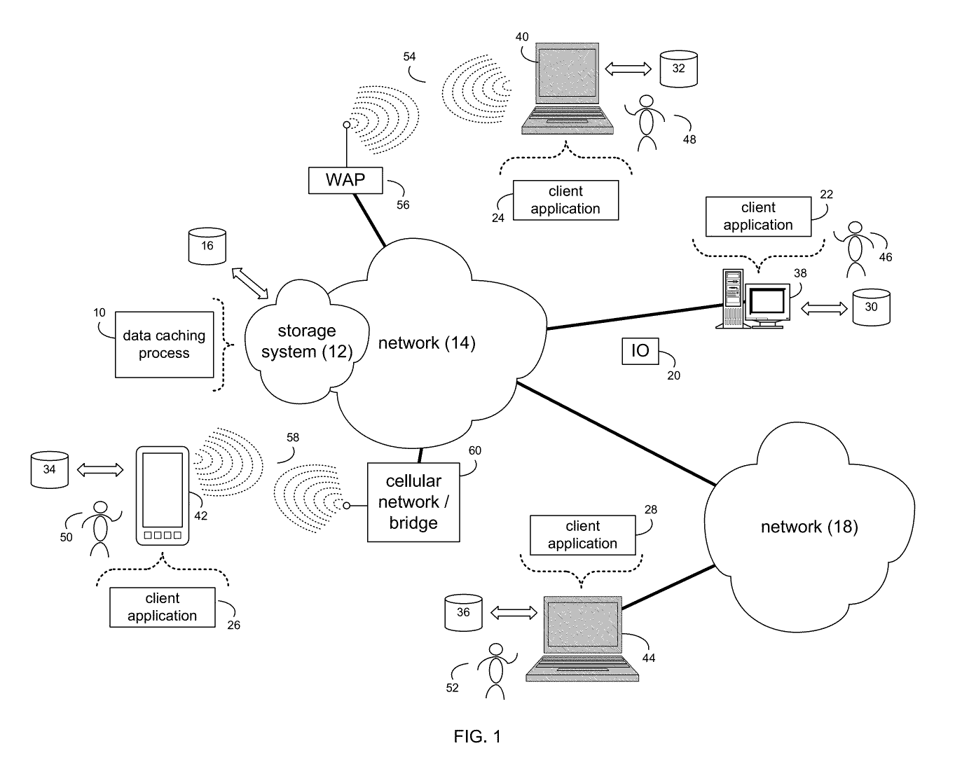

Referring to FIG. 1, there is shown cache management process 10 that may reside on and may be executed by storage system 12, which may be connected with/incorporated into/a portion of network 14 (e.g., the Internet or a local area network). Examples of storage system 12 may include, but are not limited to a plurality of web servers and/or network addressable storage devices. As will be discussed below in greater detail, the various components of storage system 12 may execute one or more operating systems.

Network 14 may be connected to one or more secondary networks (e.g., network 18), examples of which may include but are not limited to: a local area network; a wide area network; or an intranet, for example.

Various IO requests (e.g. IO request 20) may be sent from client applications 22, 24, 26, 28 to storage system 12. Examples of IO request 20 may include but are not limited to data write requests (i.e. a request that content be written to storage system 12) and data read requests (i.e. a request that content be read from storage system 12).

The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID devices; random access memories (RAM); read-only memories (ROM), and all forms of flash memory storage devices. Examples of client electronic devices 38, 40, 42, 44 may include, but are not limited to, personal computer 38, laptop computer 40, personal digital assistant 42, notebook computer 44, a server computer (not shown), a data-enabled, cellular telephone (not shown), a data-enabled television (not shown), a gaming console (not shown), and a dedicated network device (not shown). Users 46, 48, 50, 52 may access storage system 12 directly through network 14 or through secondary network 18.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 54 established between laptop computer 40 and wireless access point (i.e., WAP) 56, which is shown directly coupled to network 14. WAP 56 may be, for example, an IEEE 802.11a, 802.11b, 802.11g, 802.11n, Wi-Fi, and/or Bluetooth device that is capable of establishing wireless communication channel 54 between laptop computer 40 and WAP 56. Personal digital assistant 42 is shown wirelessly coupled to network 14 via wireless communication channel 58 established between personal digital assistant 42 and cellular network/bridge 60, which is shown directly coupled to network 14.

Client electronic devices 38, 40, 42, 44 may each execute an operating system. For illustrative purposes, storage system 12 will be described as including a plurality of web servers that serve webpages in response to data read requests provided by one or more of client electronic devices 38, 40, 42, 44. However, this is for illustrative purposes only and is not intended to be a limitation of this disclosure, as other configurations are possible and are considered to be within the scope of this disclosure.

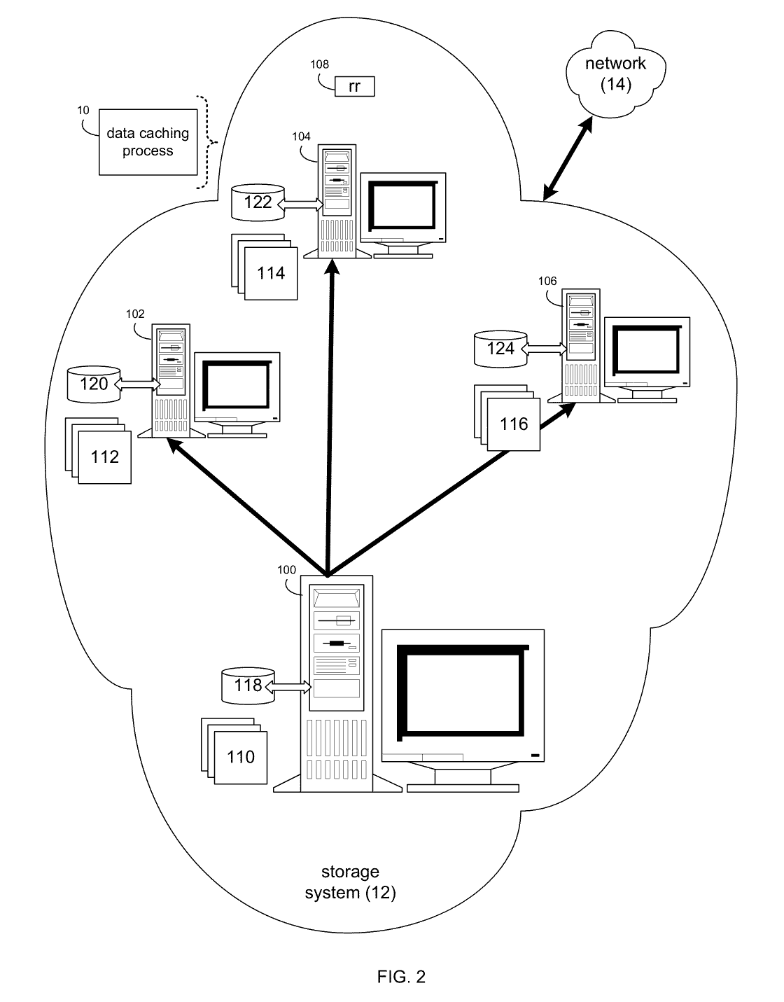

Referring also to FIG. 2, storage system 12 is shown to include a plurality of servers (e.g., servers 100, 102, 104, 106) that may be configured to process read requests (e.g., read request 108) concerning one or more webpages served by one or more of servers 100, 102, 104, 106. Specifically, one server (e.g., server 100) may be configured as the primary content server (e.g., wherein the original copies of web content 110 may be stored) and the other servers (e.g., servers 102, 104, 106) may be configured as cached content servers, wherein cached copies of web content 110 may be stored (as web content 112, 114, 116).

Servers 100, 102, 104, 106 may execute one or more operating systems. As discussed above, cache management process 10 may reside on and may be executed by storage system 12. Accordingly, one or more of servers 100, 102, 104, 106 may each execute all or a portion of cache management process 10 in a cooperative fashion.

The instruction sets and subroutines of cache management process 10, which may be stored on a storage device (e.g., one or more of storage devices 118, 120, 122, 124) included within storage system 12, may be executed by one or more processors (not shown) and one or more memory architectures (not shown) included within a server (e.g., one or more of servers 100, 102, 104, 106) included within storage system 12. Storage devices 118, 120, 122, 124 may include but are not limited to: hard disk drives; tape drives; optical drives; RAID devices; random access memories (RAM); read-only memories (ROM); and all forms of flash memory storage devices.

Cache management process 10 may be configured to host web content 110 on a first computing device (e.g., server 100), wherein copies of web content 110 may be cached on one or more second computing devices (e.g., servers 102, 104, 106), thus defining cached web content (e.g., web content 112 on server 102, web content 114 on server 104, and web content 116 on server 106).

Assume for illustrative purposes that servers 100, 102, 104, 106 are geographically dispersed, wherein e.g., server 100 is located in Australia, server 102 is located in Europe, server 104 is located in North America, and server 106 is located in Asia. Further, assume that web content 110 is a portion of a weblog/website that is read by various users (e.g., users 46, 48, 50, 52). Accordingly, users 46, 48, 50, 52 may frequently visit the URL (i.e., uniform resource locator) associated with this weblog/website and read entries posted to the weblog.

While a weblog is used as an example of locally-stored web content 110, this is for illustrative purposes only and is not intended to be a limitation of this disclosure, as other configuration are possible. For example, any website that generates non-dynamic page content (e.g., content that is not dependent upon the reader or has time dependencies, etc. . . . ) may be processed by cache management process 10.

Further assume that users 46, 48, 50, 52 are geographically dispersed, with user 46 being located in New Zealand, user 48 being located in Ireland, user 50 being located in California, and user 52 being located in Japan. In order to enhance the efficiency of serving the webpages associated with the weblog/website, users may be routed to the most geographically proximate server. For example, user 46 (located in New Zealand) may be routed to server 100 (located in Australia); user 48 (located in Ireland) may be routed to server 102 (located in Europe); user 50 (located in California, USA) may be routed to server 104 (located in North America); and user 52 (located in Japan) may be routed to server 106 (located in Asia).

Accordingly, in order for such a system to function properly, web content 112 on server 102, web content 114 on server 104, and web content 116 on server 106 may only be used to satisfy a read request from a user if such web content is current (with respect to web content 110 on server 100). In the event that web content 112, web content 114 and/or web content 116 is not current (e.g., web content 110 is newer), the appropriate server (chosen from servers 102, 104, 106, respectively) would first need to: obtain a copy of the “newer” web content 110 from server 100; update the appropriate cached copy of the web content (chosen from web content 112, 114, 116, respectively) stored on the appropriate server (chosen from servers 102, 104, 106, respectively); and provide the “updated” version of the web content (chosen from web content 112, 114, 116, respectively) to the requesting user (chosen from users 46, 48, 50, 52).

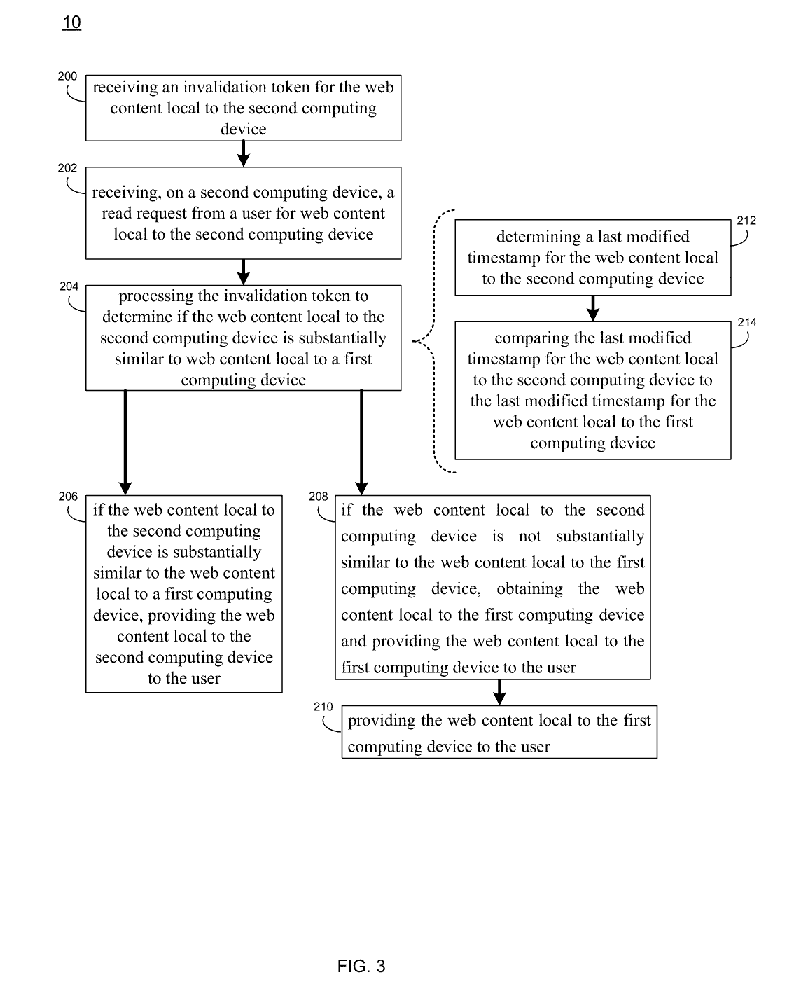

Referring also to FIGS. 3 & 4, in order to ensure that content 112, 114, 116 is current, cache management process 10 may define an invalidation token (e.g., invalidation tokens 300, 302) for web content 110. For example, assume that web content 110 includes a plurality of webpages of a blog, namely original webpage 304 and original webpage 306. As discussed above, copies of web content 110 (e.g., original webpages 304, 306) may be cached (e.g., as web content 114) on one or more second computing devices (e.g., server 104). Assume for illustrative purposes that web content 114 includes cached webpage 308 (which is a cached version of original webpage 304) and cached webpage 310 (which is a cached version of original webpage 306).

Invalidation token 300, 302 may define a last modified timestamp for web content 110. This last modified timestamp may be the last date that changes were made to the webpage in question. Specifically, if original webpage 304 was last modified on 31 Dec. 2012, invalidation token 300 (which corresponds to original webpage 304) may define a last modified timestamp of 31 Dec. 2012. Further, if original webpage 306 was last modified on 26 Dec. 2012, invalidation token 302 (which corresponds to original webpage 306) may define a last modified timestamp of 26 Dec. 2012.

Once cache management process 10 defines (in this example) invalidation tokens 300, 302, cache management process 10 may distribute these invalidation tokens (e.g., invalidation tokens 300, 302) to the other computing devices (e.g., servers 102, 104, 106). Once received 200, invalidation tokens 300, 302 may be stored (as invalidation tokens 300′, 302′) on the one or more second computing devices (e.g., servers 102, 104, 106) for future processing.

Assume for illustrative purposes that user 50 would like to read a portion of the above-described weblog (namely original webpages 304, 306). Read request 108 may be generated by client electronic device 42 and routed to the appropriate server. As user 50 is located in California, USA, read request 108 would be routed to server 104 (which is located in North America). Upon receiving 202 read request 108 on server 104, cache management process 10 may process read request 108 to determine if cached copies of web content 110 (namely original webpages 304, 306) are available on server 104.

If cached copies of web content 110 (namely original webpages 304, 306) are not available on server 104, a copy of web content 110 may be obtained from server 100; stored within server 104; and provided to user 50.

If, however, cached copies of web content 110 (namely original webpages 304, 306) are available on server 104 (in the form of cached webpages 308, 310 local to the second computing device), cache management process 10 may need to determine whether or not cached webpages 308, 310 are current (with respect to original webpages 304, 306 local to the first computing device). Accordingly, cache management process 10 may process 204, on the one or more second computing devices (e.g., server 104), the invalidation tokens (e.g., invalidation tokens 300′, 302′) to determine if web content 114 (namely cached webpages 308, 310 local to the second computing device) is substantially similar to web content 110 (namely original webpages 304, 306 local to the first computing device).

For this disclosure, webpages may be considered substantially similar if they are dissimilar in a manner that does not impact the content of the webpage. For example, if cached webpages 308, 310 have the same content as original webpages 304, 306, except for e.g., header information, footer information, formatting codes, etc., webpages 308, 310, 304, 306 may be considered substantially similar. Accordingly, substantially similar is not intended to mean identical.

If web content 114 (namely cached webpages 308, 310 local to the second computing device) is substantially similar to web content 110 (namely original webpages 304, 306 local to the first computing device), cache management process 10 may provide 206 the cached web content (namely cached webpages 308, 310 local to the second computing device) to user 50, thus satisfying read request 108.

Conversely, if web content 114 (namely cached webpages 308, 310 local to the second computing device) is not substantially similar to web content 110 (namely original webpages 304, 306 local to the first computing device), cache management process 10 may obtain 208 web content 110 (namely original webpages 304, 306 local to the first computing device) from the first computing device (e.g., server 100) and may provide 210 the web content 110 (namely original webpages 304, 306 local to the first computing device) to user 50, thus satisfying read request 108.

When processing 204 the invalidation tokens (e.g., invalidation tokens 300′, 302′) to determine if web content 114 (namely cached webpages 308, 310 local to the second computing device) is substantially similar to web content 110 (namely original webpages 304, 306 local to the first computing device), cache management process 10 may determine 212 a last modified timestamp for web content 114 (namely cached webpages 308, 310 local to the second computing device) and compare 214 the last modified timestamp for web content 110 (namely original webpages 304, 306 local to the first computing device) to the last modified timestamp for web content 114 (namely cached webpages 308, 310 local to the second computing device).

Accordingly, web content 114 (namely cached webpages 308, 310 local to the second computing device) would be considered substantially similar to web content 110 (namely original webpages 304, 306 local to the first computing device) if the last modified timestamp for web content 114 matches the last modified timestamp for web content 110. Conversely, web content 114 (namely cached webpages 308, 310 local to the second computing device) would not be considered substantially similar to web content 110 (namely original webpages 304, 306 local to the first computing device) if the last modified timestamp for web content 114 is older than the last modified timestamp for web content 110.

Continuing with the above-stated example, assume that upon processing 204 invalidation tokens 300′, 302′ on server 104, cache management process 10 determines a last modified timestamp of 31 Dec. 2012 (for original webpage 304 local to the first computing device) and a last modified timestamp of 26 Dec. 2012 (for original webpage 306 local to the first computing device). Further assume that upon processing read request 108, cache management process 10 determines 212 a last modified timestamp of 31 Dec. 2012 (for cached webpage 308 local to the second computing device) and a last modified timestamp of 21 Dec. 2012 (for cached webpage 310 local to the second computing device).

Since cached webpage 308 and original webpage 304 have the same last modified timestamp (namely 31 Dec. 2012), cached webpage 308 and original webpage 304 are substantially similar. Accordingly, cache management process 10 may provide 206 cached webpage 308 to user 50, thus partially satisfying read request 108.

However, since cached webpage 310 and original webpage 306 do not have the same last modified timestamp (namely 21 Dec. 2012 vs. 26 Dec. 2012, respectively), cached webpage 310 and original webpage 306 are not substantially similar, as original webpage 306 was updated after cached webpage 310 was stored on server 104. Accordingly, cache management process 10 may obtain 208 original webpage 306 (which is more recently updated) from server 100 and provide 210 the updated version of original webpage 306 (as represented by updated webpage 312) to user 50, thus satisfying the remainder of read request 108.

While the system is described above as utilizing invalidation tokens that define a last modified timestamp that is a date, other configurations are possible and are considered to be within the scope of this disclosure and the related claims. For example, the invalidation tokens may define a last modified timestamp that is a revision number. Alternatively, the invalidation token may be a hash or checksum of all the underlying material that makes up web content 110 (e.g., posts, comments, images and even source or binary code). Accordingly, if web content 110 changes, then the invalidation token would change and invalidate web content 114.

The present disclosure may be embodied as a method, a system, or a computer program product. Accordingly, the present disclosure may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to implementations of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent without departing from the scope and spirit of the disclosure. The implementation was chosen and described in order to best explain the principles of the disclosure and the practical application, and to enable others to understand the disclosure for various implementations with various modifications as are suited to the particular use contemplated.

A number of implementations have been described. Having thus described the disclosure of the present application in detail and by reference to implementations thereof, it will be apparent that modifications and variations are possible without departing from the scope of the disclosure defined in the appended claims.

1. A computer-implemented method comprising:
receiving, on a second computing device, a read request from a user for web content local to the second computing device, wherein the second computing device is most geographically proximate to current location of the user;
receiving, from a first computing device, an invalidation token for the web content local to the second computing device, wherein the invalidation token includes a last modified timestamp for the web content local to the second computing device and the first computing device includes a most updated version of the web content local to the second computing device;
processing the invalidation token to determine if the web content local to the second computing device is substantially similar to web content local to the first computing device, wherein the web content local to the first computing device is the most updated version of the web content local to the second computing device;
if the web content local to the second computing device is substantially similar to the web content local to a first computing device, providing the web content local to the second computing device to the user; and
if the web content local to the second computing device is not substantially similar to the web content local to the first computing device, obtaining the web content local to the first computing device and providing the web content local to the first computing device to the user.

2. The computer-implemented method of claim 1 wherein the web content local to the first computing device is at least a portion of a website.

3. The computer-implemented method of claim 1 wherein the web content local to the first computing device is at least a portion of a weblog.

4. The computer-implemented method of claim 1 wherein the invalidation token includes a last modified timestamp for the web content local to the first computing device.

5. The computer-implemented method of claim 4 wherein processing the invalidation token to determine if the web content local to the second computing device is substantially similar to the web content local to the first computing device includes:
determining the last modified timestamp for the web content local to the second computing device.

6. The computer-implemented method of claim 5 wherein processing the invalidation token to determine if the web content local to the second computing device is substantially similar to the web content local to the first computing device includes:
comparing the last modified timestamp for the web content local to the second computing device to the last modified timestamp for the web content local to the first computing device.

7. The computer-implemented method of claim 6 wherein the web content local to the second computing device is substantially similar to the web content local to the first computing device if the last modified timestamp for the web content local to the second computing device matches the last modified timestamp for the web content local to the first computing device.

8. The computer-implemented method of claim 6 wherein the web content local to the second computing device is not substantially similar to the web content local to the first computing device if the last modified timestamp for the web content local to the second computing device is older than the last modified timestamp for the web content local to the first computing device.

9. A computer program product residing on a non-transitory computer readable medium having a plurality of instructions stored thereon which, when executed by a processor, cause the processor to perform operations comprising:
receiving, on a second computing device, a read request from a user for web content local to the second computing device, wherein the second computing device is most geographically proximate to current location of the user;
receiving, from a first computing device, an invalidation token for the web content local to the second computing device, wherein the invalidation token includes a last modified timestamp for the web content local to the second computing device and the first computing device includes a most updated version of the web content local to the second computing device;
processing the invalidation token to determine if the web content local to the second computing device is substantially similar to web content local to the first computing device, wherein the web content local to the first computing device is the most updated version of the web content local to the second computing device;
if the web content local to the second computing device is substantially similar to the web content local to a first computing device, providing the web content local to the second computing device to the user; and
if the web content local to the second computing device is not substantially similar to the web content local to the first computing device, obtaining the web content local to the first computing device and providing the web content local to the first computing device to the user.

10. The computer program product of claim 9 wherein the web content local to the first computing device is at least a portion of a website.

11. The computer program product of claim 9 wherein the web content local to the first computing device is at least a portion of a weblog.

12. The computer program product of claim 9 wherein the invalidation token includes a last modified timestamp for the web content local to the first computing device.

13. The computer program product of claim 12 wherein processing the invalidation token to determine if the web content local to the second computing device is substantially similar to the web content local to the first computing device includes:
determining the last modified timestamp for the web content local to the second computing device.

14. The computer program product of claim 13 wherein processing the invalidation token to determine if the web content local to the second computing device is substantially similar to the web content local to the first computing device includes:
comparing the last modified timestamp for the web content local to the second computing device to the last modified timestamp for the web content local to the first computing device.

15. The computer program product of claim 14 wherein the web content local to the second computing device is substantially similar to the web content local to the first computing device if the last modified timestamp for the web content local to the second computing device matches the last modified timestamp for the web content local to the first computing device.

16. The computer program product of claim 14 wherein the web content local to the second computing device is not substantially similar to the web content local to the first computing device if the last modified timestamp for the web content local to the second computing device is older than the last modified timestamp for the web content local to the first computing device.

17. A computing system including a processor and memory configured to perform operations comprising:
receiving, on a second computing device, a read request from a user for web content local to the second computing device, wherein the second computing device is most geographically proximate to current location of the user;
receiving, from a first computing device, an invalidation token for the web content local to the second computing device, wherein the invalidation token includes a last modified timestamp for the web content local to the second computing device and the first computing device includes a most updated version of the web content local to the second computing device;
processing the invalidation token to determine if the web content local to the second computing device is substantially similar to web content local to the first computing device, wherein the web content local to the first computing device is the most updated version of the web content local to the second computing device;
if the web content local to the second computing device is substantially similar to the web content local to a first computing device, providing the web content local to the second computing device to the user; and
if the web content local to the second computing device is not substantially similar to the web content local to the first computing device, obtaining the web content local to the first computing device and providing the web content local to the first computing device to the user.

18. The computing system of claim 17 wherein the web content local to the first computing device is at least a portion of a website.

19. The computing system of claim 17 wherein the web content local to the first computing device is at least a portion of a weblog.

20. The computing system of claim 17 wherein the invalidation token includes a last modified timestamp for the web content local to the first computing device.

21. The computing system of claim 20 wherein processing the invalidation token to determine if the web content local to the second computing device is substantially similar to the web content local to the first computing device includes:
determining the last modified timestamp for the web content local to the second computing device.

22. The computing system of claim 21 wherein processing the invalidation token to determine if the web content local to the second computing device is substantially similar to the web content local to the first computing device includes:
comparing the last modified timestamp for the web content local to the second computing device to the last modified timestamp for the web content local to the first computing device.

23. The computing system of claim 22 wherein the web content local to the second computing device is substantially similar to the web content local to the first computing device if the last modified timestamp for the web content local to the second computing device matches the last modified timestamp for the web content local to the first computing device.

24. The computing system of claim 22 wherein the web content local to the second computing device is not substantially similar to the web content local to the first computing device if the last modified timestamp for the web content local to the second computing device is older than the last modified timestamp for the web content local to the first computing device.
